(19) United States
(12) Patent Application Publication
(10) Pub. No.: US 2008/0041196 A1
(43) Pub. Date: Feb. 21, 2008

(54) Surgical Screw Insertion Devices and Methods of Use

(75) Inventors: Wilder Companioni, Cordova, TN (US); Carl M. Stamp, Collierville, TN (US); Alexander R. Vaccaro, Gladwyne, PA (US)

Correspondence Address: COATS & BENNETT, PLLC, 1400 Crescent Green, Suite 300, Cary, NC, 27518, US

(73) Assignee: WARSAW ORTHOPEDIC INC., Warsaw, IN (US)

(21) Appl. No.: 11/464,898

(22) Filed: Aug. 16, 2006

(51) Int. Cl. B25B 23/10; B25B 23/08

(52) U.S. Cl. 81/453

(57) ABSTRACT

The present application is directed to devices and methods for inserting and mounting a fastener into a patient during a surgical procedure. In one embodiment, the device includes inner and outer sleeves. The inner sleeve may include a distal end that is configured to maintain the screw. In one embodiment, the outer sleeve may axially move along the inner sleeve to control an attachment force that is applied by the inner sleeve to maintain attachment of the fastener. In one method of use, the fastener is attached to the inner sleeve with the outer sleeve positioned to apply an attachment force. A handle of the device may be manipulated to position the fastener within the patient. Once positioned, the handle may be rotated to mount the fastener within a support member. As a head of the fastener is approaching the support member, the fastener disengages from the inner sleeve and remains within the patient.

### BACKGROUND

The present application is directed to screw insertion devices and methods and, more particularly, to devices and methods for attaching a screw to a tool that securely maintains the screw during positioning within the patient and allows removal as the screw is being mounted to a support member within the patient.

Various surgical procedures utilize one or more fasteners that are attached within the patient. The fasteners include a shaft that is inserted into a support member such as an implant, bone, or tissue. The fastener further includes a head positioned at an end of the shaft that includes a receiver for engagement with a screwdriver. The shaft may include threads to assist in inserting the screw into the support member and in preventing the screw from backing out of the support member. The head may include a variety of different receivers with different shapes and sizes depending upon the context of use.

Common practice is using a screwdriver for inserting the fasteners. Most screwdrivers include a tip that engages the receiver and a shaft to rotate the fastener and drive it into the support member. The screwdriver may further include a handle that is grasped and rotated by the surgeon to insert the fastener into the support member.

One problem with these screwdrivers is the inability to maintain the fastener attached to the tip prior to insertion into the support member. In many surgical procedures, the fastener is placed within the body in relatively small or tight areas. If the fastener is loosely attached to the screwdriver, it may release while being positioned within the patient or become misaligned with the central axis of the screwdriver shaft. Alternatively, if secured too firmly, the fastener may not release from the screwdriver after being mounted to the support member.

### SUMMARY

The present application is directed to devices and methods for inserting and mounting a fastener into a patient during a surgical procedure. In one embodiment, the device includes inner and outer sleeves. The inner sleeve may include a distal end that is configured to maintain the screw. In one embodiment, the outer sleeve may axially move along the inner sleeve to control an attachment force that is applied by the inner sleeve to maintain attachment of the fastener.

In one method of use, the fastener is attached to the inner sleeve with the outer sleeve positioned to apply an attachment force. A handle of the device may be manipulated to position the fastener within the patient. Once positioned, the handle may be rotated to mount the fastener within a support member. As a head of the fastener is approaching the support member, the fastener slides from the inner sleeve and remains within the patient.

### BRIEF DESCRIPTION OF THE DRAWINGS

FIG. 1 is a perspective view illustrating a tool according to one embodiment.

FIG. 2 is an exploded perspective view illustrating a tool according to one embodiment.

FIG. 3 is a partial perspective view illustrating a tip of an inner sleeve according to one embodiment.

FIG. 4A is a side schematic view illustrating a tool in an open orientation according to one embodiment.

FIG. 4B is a side schematic view illustrating the tool in a closed orientation according to one embodiment.

FIGS. 5A-C are side schematic views illustrating a method of mounting a fastener to a support member according to one embodiment.

FIG. 6 is a perspective view illustrating a tip of an inner sleeve according to one embodiment.

FIG. 7 is a partial perspective view illustrating a tip of an inner sleeve according to one embodiment.

### DETAILED DESCRIPTION

The present application is directed to surgical devices and methods for inserting and mounting a fastener within a patient. In one embodiment, the devices and methods securely attach the fastener while being inserted and positioned within the patient. The devices and methods may also provide for releasing the fastener during mounting to a support member within the patient.

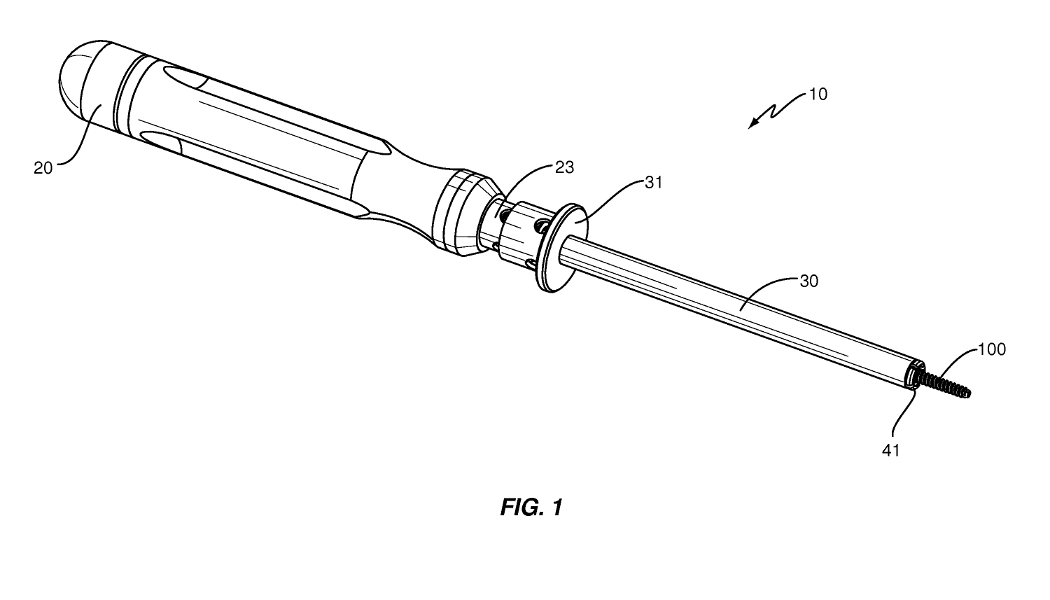

FIG. 1 illustrates one embodiment of the device, generally illustrated as 10. The device 10 includes a handle 20 sized for grasping by a surgeon. An outer sleeve 30 extends outward relative to the handle 20. A flange 31 operatively connected to the outer sleeve 30 provides a means for grasping by the surgeon to move the outer sleeve 30. A distal end 41 of an inner sleeve 40 may extend outward from the outer sleeve 30 and attach to the fastener 100. FIG. 1 illustrates the device 10 in a first orientation with the fastener 100 attached at the distal end 41. In this orientation, the surgeon can grasp and manipulate the handle 20 to position the fastener 100 within the patient. Once positioned, the surgeon can rotate the handle 20 to mount the fastener 100 within a support member 200 in the patient. The fastener disengages from the distal end 41 during mounting.

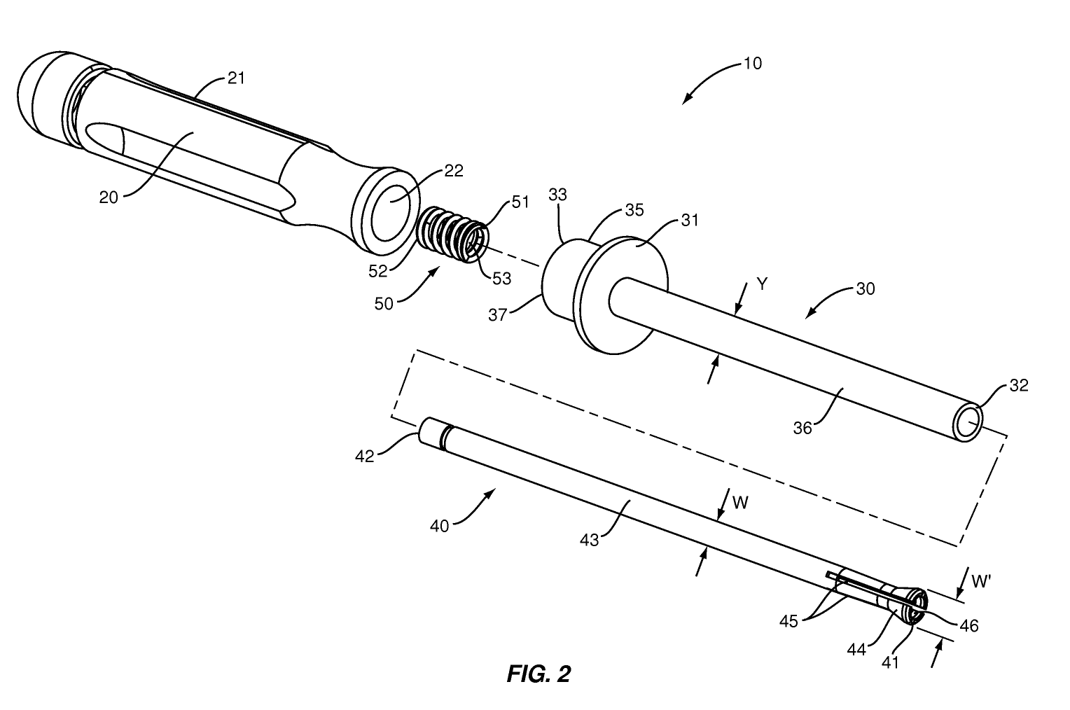

FIG. 2 illustrates an exploded view of one embodiment of a device 10. In this embodiment, the main components include a handle 20, biasing member 50, outer sleeve 30, and an inner sleeve 40.

Handle 20 provides a surface for grasping and manipulating the device 10. Handle 20 is grasped by the surgeon and rotated to apply torque to the fastener 100 during mounting into the support member 200. Handle 20 may also be used to apply a downward force to further facilitate insertion of the fastener 100. In one embodiment, handle 20 is positioned on a proximal end of the inner sleeve 40. In another embodiment, handle 20 is positioned along a central section of the inner sleeve 40. In one embodiment, two or more handles 20 are positioned along the device 10. In one embodiment, handle 20 includes a width that is greater than either of the inner and outer sleeves 40, 30. Handle 20 may include a varying width including relatively wide and narrow sections. Handle 20 may further include an ergonomic shape. In one embodiment, handle 20 includes surface features 21 such as indents, and knurled or textured surfaces to prevent slippage. In one embodiment, the handle 20 is removably attached to the inner sleeve 40.

In one embodiment, an aperture 22 is positioned at a distal end of the handle 20. Aperture 22 may include a bottom wall (not illustrated) that supports the biasing member 50. In one embodiment, aperture 22 is sized to contain a section or the entirety of the biasing member 50. Aperture 22 may include a variety of different depths and widths. In one embodiment, handle 20 does not include an aperture 22 with the distal end being substantially flat to support the biasing member 50.

The inner sleeve 40 extends from the handle 20. In one embodiment, a proximal end 42 is attached to the handle 20 with the distal end 41 extending outward from the handle 20. In one embodiment, the inner sleeve 40 includes a length to maintain the handle 20 on the exterior of the patient while positioning and mounting the fastener 100 within the patient. In one embodiment, the inner sleeve 40 includes a first section 43 and a second section 44. In one embodiment, the first section 43 includes a substantially constant width w. In one embodiment, the first section 43 extends from the proximal end 42 towards the distal end 41. In one embodiment, the first section 43 is solid. In another embodiment, the first section 43 is hollow. In one embodiment, a portion of the first section 43 is solid, with the remainder being hollow. In one embodiment, the second section 44 is constructed of a transparent or translucent material to visually observe the fastener 100. Examples of materials for the inner sleeve 40 and the outer sleeve 30 include but are not limited to 17-4 PH Stainless Steel, 455 or 465-Stainless Steel, Titanium Alloys, and other metals commonly used in surgical instruments. Materials may also include plastics, acetal co-polymer, and polyetheretherketone (PEEK).

In one embodiment, the second section 44 is flared and increases in width from the first width w to a larger width w′ at the distal end 41. The amount of flare in the second section 44 may vary depending upon the context of use. In one embodiment as illustrated in FIG. 2, the second section 44 has a limited length that extends inward from the distal end 41. In other embodiments, the second section 44 may be shorter or longer.

In one embodiment, one or more slots 45 extend inward from the distal end. The slots 45 provide for adjusting the width w′ of the second section 44. The length of the slots 45 may vary depending upon the context of use. In one embodiment as illustrated in FIG. 2, the slots 45 extend through the entire length of the second section 44 and into the first section 43. In one embodiment, the slots 45 extend a length less than that of the second section 44.

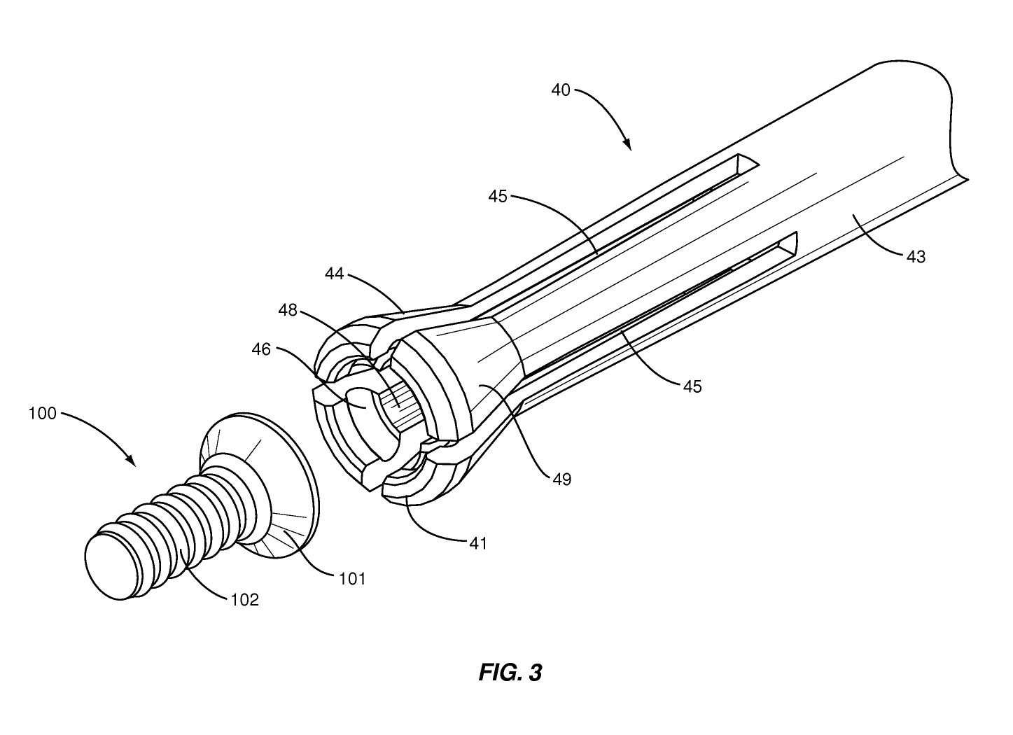

FIG. 3 illustrates one embodiment of the inner sleeve 40 and a fastener 100. This embodiment includes four slots 45 extending from the distal end 41 and extending through a portion of the second section 44. In one embodiment, the slots 45 are evenly spaced around the periphery of the inner sleeve 40. In one embodiment as illustrated in FIG. 3, each of the slots 45 includes substantially the same width and length. In other embodiments, slots 45 may include different widths and lengths. In one embodiment, an outer surface 49 of the second section 44 is substantially smooth.

In one embodiment, a groove 46 is positioned in an inner surface 48 of the second section 44 in proximity to the distal end 41. In one embodiment as illustrated in FIG. 3, the groove 46 is sized to receive the head 101 of the fastener 100. In one embodiment, the groove 46 is horizontally aligned and substantially perpendicular to a longitudinal axis of the inner sleeve 40. In one embodiment, the groove 46 is sized to receive the head 101 and axially align the fastener 100 within the inner sleeve 40. In one embodiment, a single groove 46 is positioned within the inner surface 48. In another embodiment, two or more grooves 46 are positioned within the inner surface 48.

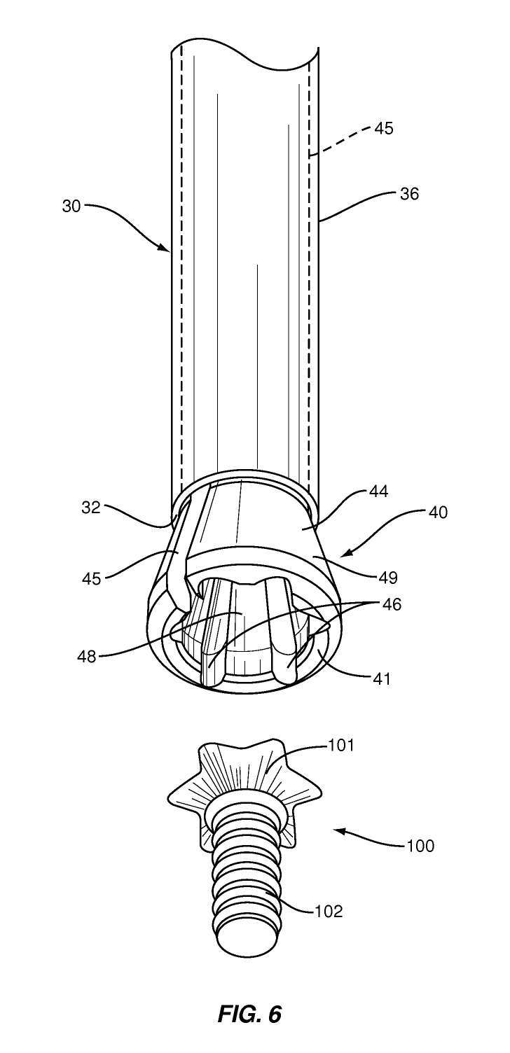

FIG. 6 illustrates one embodiment including a plurality of grooves 46 positioned on the inner surface 48. In this embodiment, the grooves 46 are positioned in a vertical manner. The grooves 46 are sized to match the configuration of the head 101. In one embodiment, six grooves 46 are positioned along the inner surface 48 to correspond to the six protrusions on the head 101.

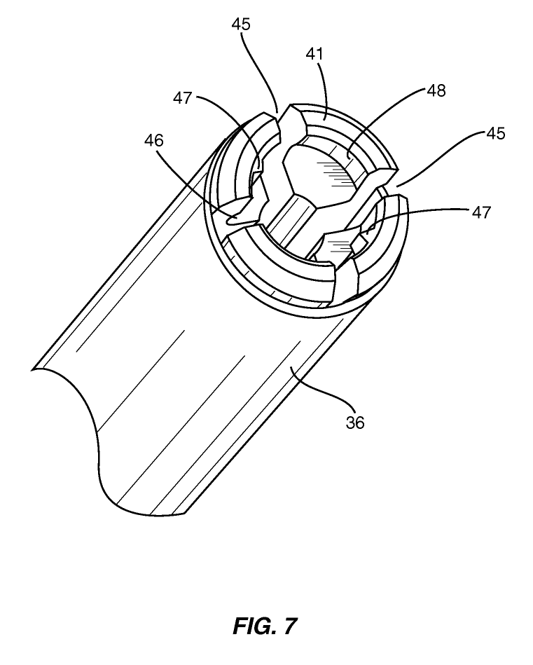

FIG. 7 illustrates another embodiment with one or more ridges 47 extending along the inner surface 48. The ridges 47 are sized to engage protrusions on the head 101 of the externally driven fastener 100 and transfer torque from the device 10 to the fastener 100. As the fastener 100 is inserted, the head 101 rides along the ridges 47 to transfer the torque and also maintain alignment. In one embodiment, the ridges 47 extend between the distal end 41 and the groove 46, although other embodiments may include other distances.

In one embodiment, fastener 100 is an externally driven hexalobular screw or external Torx screw. One specific embodiment includes resorbable screws used in the MYSTIQUE Resorbable Graft Containment System available from Medtronic Sofamor Danek of Memphis, Tenn. Fastener 100 may be constructed from a variety of materials including Hydrosorb (70% poly-L-lactide-co-30% D,L-lactide or PLDLA), poly-ether-ether-ketone (PEEK), or a variety of other polymers and materials used to make non-metallic implantable screws. In one embodiment, the grooves 46 extend from the distal end 41 inward along the inner surface 48. In one embodiment, the grooves 46 are spaced inward from the distal end 41. The grooves 46 contain the head 101 and axially align the fastener 100 within the inner sleeve 40. In one embodiment including vertical grooves 46, the second section 44 includes fewer slots 45.

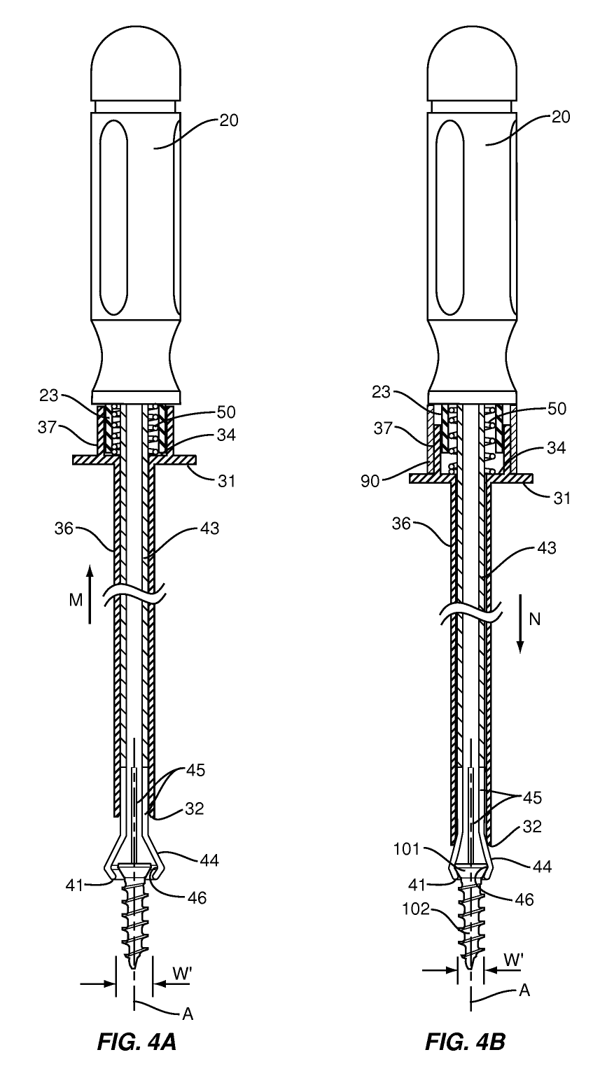

Returning to FIG. 2, the outer sleeve 30 is sized to extend over the inner sleeve 40. In one embodiment, the outer sleeve 30 includes a first section 35 and a second section 36. In one embodiment, the first section 35 forms an area including sidewalls 37 and a floor 34 (FIGS. 4A and 4B) to position the biasing member 50. The sidewalls 37 may extend outward from the floor 34 a variety of distances. In one embodiment, the sidewalls 37 are sized to fit within the aperture 22 in the handle 20. The floor 34 is sized to support the biasing member 50, and includes an aperture (not illustrated) to allow the inner sleeve 40 to extend within the outer sleeve 30.

In one embodiment, a flange 31 extends radially outward from the first section 35. In one embodiment, the flange 31 is aligned with and extends outward from the floor 34. In one embodiment, the flange 31 includes a greater width than the second section 36. The flange 31 provides a contact surface for moving the outer sleeve 30 axially in a proximal direction as will be explained in more detail below. In one embodiment, the outer sleeve 30 is centered within the flange 31. In another embodiment, the outer sleeve 30 is offset relative to the flange 31. In one embodiment as illustrated in FIG. 1, the flange 31 includes a circular shape. In other embodiments, flange 31 may include a variety of different shapes.

The second section 36 of the outer sleeve 30 extends outward from the first section 35 and terminates at the distal end 32. In one embodiment, the second section 36 includes a substantially constant width Y. In other embodiments, the width may vary along the length. In one embodiment, the width Y is less than the width of the second section 44 of the inner sleeve 40. In one embodiment, the walls of the second section 36 are solid. In other embodiments, one or more apertures are positioned along the second section 36.

The biasing member 50 biases the outer sleeve 30 in a distal direction along the inner sleeve 40. In one embodiment as illustrated in FIG. 2, the biasing member comprises a coil spring including a central opening 53 sized to extend around the inner sleeve 40. In one embodiment, biasing member 50 includes a first end 51 that contacts the floor 34 of the outer sleeve 30 and a second end 52 that contacts the handle 20. As illustrated in FIG. 1, the biasing member 50 includes a length to maintain the outer sleeve 30 spaced away from the handle 20. In one embodiment, the device 10 includes a single biasing member 50. In another embodiment, the device 10 includes two or more biasing members 50.

In one embodiment as illustrated in FIG. 1, biasing member 50 is maintained within an internal area formed between the handle 20 and the outer sleeve 30. This arrangement may prevent the biasing member 50 from contacting the patient during insertion and mounting of the fastener 100. In one embodiment, the first end 51 is positioned within the sidewall 37 of the outer sleeve 30, and the second end 52 is positioned within the aperture 22 in the handle 20. In another embodiment, the second end 52 is positioned within a wall 23 that extends from the distal end of the handle 20 (FIGS. 4A and 4B). In one embodiment, the biasing member 50 is exposed.

When no external forces are acting on the device 10, the biasing member 50 forces the outer sleeve 30 in a distal direction. This causes the distal end 32 of the outer sleeve 30 to overlap with the second section 44 and position the second section 44 in a closed orientation. In one embodiment, initially attaching the fastener 100 to the device 10 includes moving the outer sleeve 30 in a proximal direction relative to the inner sleeve 40.

One embodiment of the device 10 in an orientation to receive the fastener 100 is illustrated in FIG. 4A. In this embodiment, the outer sleeve 30 is moved in a proximal direction, illustrated by arrow M, relative to the inner sleeve 40. In one embodiment, this movement is caused by the surgeon contacting the flange 31 and applying a proximal force. The proximal movement overcomes the force of the biasing member 50 causing the outer sleeve 30 to move towards the handle 20. This movement compresses the biasing member 50 between the floor 34 of the outer sleeve 30 and the handle 20.

The proximal movement M also causes the distal end 32 of the outer sleeve 30 to move away from the second section 44 of the inner sleeve 40. This allows the second section 44 to move outward towards a normal position and increase the width w′ at the distal end 41. In this position, the second section 44 is sized to receive the head 101 of the fastener 100. Fastener 100 is inserted into the inner sleeve 40. In one embodiment, the fastener 100 is inserted a distance with the head 101 being aligned with the grooves 46.

After positioning the fastener 100 within the inner sleeve 40, the outer sleeve 30 is moved in a distal direction to attach the fastener 100. FIG. 4B illustrates one embodiment with the fastener 100 attached to the device 10. In this embodiment, the outer sleeve 30 is moved distally in the direction of arrow N relative to the inner sleeve 40. In one embodiment, this movement is caused when the surgeon releases the flange 31 and the biasing member 50 forces the outer sleeve 30 in the distal direction. In one embodiment, the distal end 32 of the outer sleeve 30 overlaps with the second section 44. In one embodiment, the overlap is extensive with the distal end 32 of the outer sleeve 30 being positioned in close proximity to the distal end 41 of the inner sleeve 40. In another embodiment, the amount of overlap is less with the distal end 32 being spaced a distance away from the distal end 41.

The movement of the outer sleeve 30 forces the second section 44 inward and decreases the width w′. The movement applies a radial compression force on the head 101 of the fastener 100 that maintains attachment of the fastener 100. In one embodiment, the head 101 aligns within the grooves 46 on the inner surface 48 of the second section 44 to axially align the fastener 100. With the head 101 positioned within the grooves 46, a central axis A of the fastener 100 is substantially aligned with an axis of the device 10.

In the closed orientation as illustrated in FIG. 4B, the fastener 100 is firmly attached to allow for the surgeon to manipulate the handle 20 and insert the fastener 100 into the patient without the fastener 100 becoming detached. The attachment force is also adequate such that torque applied through the handle 20 is transferred through the inner sleeve 40 and to the fastener 100 during mounting to the support member 200 within the patient.

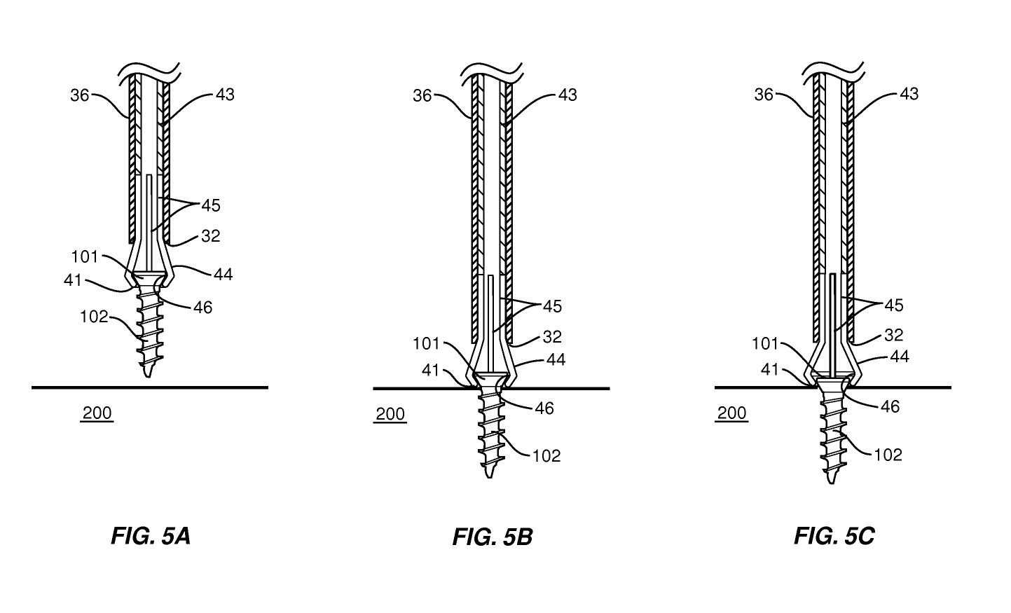

In one embodiment, the fastener 100 is detached from the device 10 during mounting within the support member 200. Support member 200 may include bone, tissue, an implant such as a plate, or a combination of two or more of these elements. FIGS. 5A-5C illustrates one embodiment of the fastener 100 being mounted within the support member 200. In the embodiment of FIG. 5A, the fastener 100 is attached within the inner sleeve 40 with the head 101 positioned within the grooves 46. The outer sleeve 30 is positioned with the distal end 32 aligned over the second section 44 to apply a compressive force to the head 101. In one embodiment, the tip 41 extends beyond the grooves 46 and is positioned between the head 101 and the support member 200. This attachment is adequate to position the fastener 100 relative to the support member 200.

Once located, the torque applied through the handle 20 is transferred through the second section 44 to the fastener 100. The torque on the fastener 100 drives the fastener 100 into the support member 200. In one embodiment, both the inner sleeve 40 and the fastener 100 rotate and move towards the support member 200. In one embodiment, the head 101 remains substantially stationary relative to the inner sleeve 40.

As illustrated in FIG. 5B, the fastener 100 has been mounted with the head 101 approaching the surface of the support member 200. At this point, the tip 41 of the inner sleeve 40 contacts the support member 200. This prevents the inner sleeve 40 from further movement into the support member 200. Continued rotation after this point causes the fastener 100 to continue moving into the support member 200 with the head 100 axially moving along the inner surface 48 of the inner sleeve 40. In one embodiment, the axial movement causes the head 101 to move out of the grooves 46. In one embodiment, movement out of the grooves 46 may cause the width w′ of the inner sleeve 40 to expand. In one embodiment, movement out of the grooves 46 causes elastic and/or plastic deformation of the head 101. In one embodiment, the movement causes both expansion of the width w′ and deformation of the head 101. In one embodiment, the expansion of the w′ causes the outer sleeve 30 to move proximally upward towards the handle 20 and overcome the force of the biasing member 50.

Continued rotation of the fastener 100 causes further axial movement of the head 101 along the inner sleeve 40 as illustrated in FIG. 5C. The contact between the inner sleeve 40 and the head 101 remains strong enough to transfer the torque to the fastener 100 that is applied through the handle 20. Eventually, the head 101 will move beyond the distal end 41 and the fastener 100 disengages from the device 10.

In one embodiment including vertical grooves 46 as illustrated in FIG. 6, the head 101 axially moves along the inner surface 48 a greater distance as the fastener 100 is mounted within the support member 200.

In one embodiment, a lock 90 is mounted to the device 10 to prevent inadvertent removal of the fastener 100. In one embodiment as illustrated in FIG. 4B, lock 90 comprises a C-shaped clip that attaches around the biasing member 50. A first edge of the lock 90 contacts the handle 20, with a second edge contacting the flange 31. The clip 90 may be constructed of a rigid member and include a length that prevents the flange 31 from being moved towards the handle 20 and thus opening the inner sleeve 40. In one embodiment, the lock 90 is applied prior to positioning of the fastener 100 within the patient. In another embodiment, lock 90 includes a peg that fits within an aperture in the inner sleeve 40 adjacent to the flange 31 to again prevent proximal movement of the outer sleeve 30.

The term “distal” is generally defined as in the direction of the patient, or away from a user of a device. Conversely, “proximal” generally means away from the patient, or toward the user. Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A device to surgically mount a fastener within a patient comprising:
an inner sleeve including a flared distal end section;
an outer sleeve positioned over the inner sleeve, the outer sleeve including a smaller width than the flared distal end section; and
a biasing member applying a force to bias the outer sleeve in a distal direction relative to the inner sleeve;
the biasing member forcing a distal end of the outer sleeve over the flared distal end section of the inner sleeve to reduce the distal end section from a first width to a second width to apply a radial compressive force along a periphery of the fastener such that torque applied to the inner sleeve is transferred to the fastener.

2. The device of claim 1, wherein a proximal end of the inner sleeve is attached to a handle, the handle including a larger width than the inner sleeve.

3. The device of claim 2, wherein a first end of the biasing member contacts the handle and a second end contacts the outer sleeve.

4. The device of claim 1, wherein the inner sleeve further includes a groove positioned within an inner surface proximate to an inner sleeve distal end, the groove being sized to align a head of the fastener.

5. The device of claim 1, further comprising a housing that extends around the biasing member to shield the biasing member during mounting of the fastener.

6. The device of claim 1, wherein the outer sleeve and the inner sleeve each include an elongated shape with a common longitudinal axis.

7. The device of claim 1, wherein the outer sleeve further includes a flange spaced away from the distal end, the flange extending outward from the outer sleeve.

8. The device of claim 1, further comprising a lock positioned between the outer sleeve and a handle to prevent the outer sleeve from moving in a proximal direction relative to the inner sleeve.

9. The device of claim 1, wherein the inner sleeve further includes an axial ridge that extends inward from the inner sleeve to engage a head of the fastener.

10. A device to surgically mount a fastener within a patient comprising:
an inner sleeve including a distal end section;
an outer sleeve positioned over the inner sleeve, the outer sleeve including a smaller width than the distal end section; and
a biasing member applying a force to bias the outer sleeve in a distal direction relative to the inner sleeve;
the biasing member being positionable between a first orientation and a second orientation, the first orientation including the biasing member with a first axial length to distally force the outer sleeve in an overlapping arrangement with the distal end section of the inner sleeve, and a second orientation with a second shorter axial length with the outer sleeve spaced from the distal end section;
the biasing member in the first orientation causing a radial compressive force to be applied along a periphery of the fastener such that torque applied to the inner sleeve is transferred to the fastener.

11. The device of claim 10, further comprising a horizontal groove positioned along an inner surface of the distal end section of the inner sleeve, the groove being sized to contact the fastener in the first orientation.

12. The device of claim 10, further comprising a plurality of vertical grooves positioned along an inner surface of the distal end section of the inner sleeve, the plurality of grooves being sized to contact the fastener in the first orientation.

13. The device of claim 10, further comprising a housing extending around the biasing member to shield the biasing member during mounting of the fastener.

14. A device to surgically mount a fastener within a patient comprising:
an elongated inner sleeve including a flared end that is movable between a first orientation with a first width and a second orientation with a second larger width;
an outer sleeve movably positioned on the inner sleeve and including a distal end and a proximal end, the distal end including a width that is smaller than the second width of the inner sleeve; and
a biasing member operatively connected to the outer sleeve to bias the outer sleeve in a distal direction relative to the inner sleeve;
the outer sleeve being movably positioned on the inner sleeve between a first position with the distal end of the outer sleeve in contact with the flared end of the inner sleeve to position the inner sleeve in the first orientation, and a second position with the distal end positioned away from the flared end to position the inner sleeve in the second orientation;
the inner sleeve applying a radially compressive force to the flared end when the outer sleeve is in the first position to transfer a torque applied to the inner sleeve to the fastener.

15. The device of claim 14, wherein the flared end assumes the second orientation in the absence of external forces.

16. The device of claim 14, wherein the outer sleeve and the inner sleeve are aligned along a common longitudinal axis.

17. The device of claim 14, wherein the biasing member includes a longer axial length when the outer sleeve is in the first position than in the second position.

18. The device of claim 14, further comprising positioned between the outer sleeve and a handle to prevent the outer sleeve from moving to the second position.

19. A method of surgically mounting a fastener to a support member within a patient, the method comprising the steps of:
positioning a fastener within an inner sleeve;
moving an outer sleeve in a distal direction along the inner sleeve and applying a radially compressive force to the fastener and attaching the fastener within the inner sleeve;
rotating the inner sleeve and transferring torque from the inner sleeve to the fastener and driving the fastener into the support member a first distance with a position of the fastener remaining stationary relative to the inner sleeve;
contacting a distal end of the inner sleeve against the support member while mounting the fastener into the support member the first distance;
continuing rotation of the inner sleeve while mounting the fastener past the first distance and axially sliding the fastener along an inner surface of the inner sleeve; and
disengaging the fastener from the inner sleeve.

20. The method of claim 19, wherein the step of positioning the fastener within the inner sleeve further comprises positioning the fastener within a horizontal groove in the inner sleeve.

21. The method of claim 19, wherein the step of positioning the fastener within the inner sleeve further comprises positioning the fastener within a plurality of vertical grooves in the inner sleeve.

22. The method of claim 21, further comprising axially sliding the fastener along the plurality of vertical grooves while mounting the fastener past the first distance.

23. The method of claim 21, further comprising axially sliding the fastener along an axial ridge that extends along a section of the inner surface of the inner sleeve.

24. The method of claim 19, wherein the step of disengaging the fastener from the inner sleeve comprises expanding a width of the inner sleeve as the fastener axially slides along the inner surface of the inner sleeve.

25. The method of claim 19, wherein the step of moving the outer sleeve in the distal direction along the inner sleeve comprises biasing the outer sleeve in the distal direction with a biasing member.

26. The method of claim 19, further comprising axially aligning the fastener relative to the inner sleeve by positioning the fastener within a groove on an inner surface of the inner sleeve.

27. A method of surgically mounting a fastener to a support member within a patient, the method comprising the steps of:
positioning a head of the fastener within a groove in an inner sleeve;
moving an outer sleeve in a distal direction along the inner sleeve and applying a radially compressive force to the fastener to attach the fastener within the groove in the inner sleeve;
rotating the inner sleeve and transferring torque from the inner sleeve to the fastener and driving the fastener into the support member as an axial position of the head relative to the inner sleeve remains relatively stationary;
contacting a distal end of the inner sleeve against the support member while driving the fastener into the support member;
continuing rotation of the inner sleeve after contacting the distal end and axially sliding the head along the inner sleeve and out of the groove; and
disengaging the fastener from the inner sleeve.

28. The method of claim 27, wherein the step of sliding the head along the inner sleeve and out of the groove further comprises expanding a width of the inner sleeve.

29. The method of claim 27, wherein the step of disengaging the fastener from the inner sleeve further comprises moving the outer sleeve in a proximal direction along the inner sleeve.

30. The method of claim 27, further comprising locking the outer sleeve and preventing the outer sleeve from moving in a proximal direction relative to the inner sleeve.

31. A method of surgically mounting a fastener in a support member within a patient, the method comprising the steps of:
positioning a head of the fastener within a vertical groove in an inner sleeve;
moving an outer sleeve in a distal direction along the inner sleeve and applying a radially compressive force to the fastener to attach the fastener within the inner sleeve;
rotating the inner sleeve and transferring torque from the inner sleeve to the fastener and driving the fastener into the support member as the head of the fastener axially slides along the vertical groove in a distal direction; and
disengaging the fastener from the inner sleeve.

32. The method of claim 31, wherein the step of moving the outer sleeve in the distal direction along the inner sleeve further comprises overlapping the outer sleeve with the inner sleeve.
